(19) United States
(12) Patent Application Publication
(10) Pub. No.: US 2024/0378603 A1
(43) Pub. Date: Nov. 14, 2024

(54) IDENTIFYING ENTITIES BASED ON AN ENTITY DISCOVERY MODEL

(71) Applicant: MASTERCARD INTERNATIONAL INCORPORATED, Purchase, NY (US)

(72) Inventors: Varun AJMERA, Toronto (CA); Ravi Santosh ARVAPALLY, Hyderabad (IN); Abtin AZARI, Thornhill (CA); Kiran SHENOY, O Fallon, MO (US)

(73) Assignee: MASTERCARD INTERNATIONAL INCORPORATED, Purchase, NY (US)

(21) Appl. No.: 18/314,042

(22) Filed: May 8, 2023

(51) Int. Cl. G06Q 20/40; G06F 9/54

(52) U.S. Cl. CPC G06Q 20/40; G06F 9/546

(57) ABSTRACT

The disclosure relates to methods and systems of performing entity discovery based on an entity discovery model. Entity discovery refers to one or more computational processes that attempt to identify an entity when the identity of the entity is unknown. The entity discovery model may include multiple discovery stages. Each discovery stage of the entity discovery model may independently attempt to identify an entity. The entity discovery model may execute the discovery stages in a waterfall execution in which a discovery stage is executed only if a prior discovery stage failed to identify the entity, potentially reducing the computational overhead of executing all discovery stages. In other examples, the entity discovery model may execute the discovery stages in a parallel execution to minimize the time it takes to perform entity discovery.

### BACKGROUND

Data communicated over a network requires connectivity between devices of the network. For example, a transmitting device requires a communication link to a receiving device in order to send an urgent electronic message to the receiving device. However, if the communication link is unavailable, then the transmitting device may be unable to provide the electronic message to the receiving device. For example, an entity may not be registered to receive electronic alert messages from an alert system. In this example, the alert system may not have a direct communication link with the entity to provide the entity with the electronic alert messages. There are other instances when a communication link is unavailable with an entity that should receive electronic messages.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment of entity discovery based on an entity discovery model;

FIG. 2 illustrates an example of performing entity discovery based on waterfall execution of discovery stages in the entity discovery model;

FIG. 3 illustrates an example of performing entity discovery based on parallel execution of discovery stages in the entity discovery model;

FIG. 4 illustrates an example of a data flow diagram for a method of performing entity discovery to identify a relay entity to establish indirect communication with a target entity;

FIG. 5 illustrates an example of a method of identifying a relay entity using an API call and waterfall execution of the entity discovery model;

FIG. 6 illustrates an example of a method of identifying an acquirer entity to relay an alert to a merchant entity; and

FIG. 7 illustrates an example of a computer system that may be implemented by devices illustrated in FIG. 1.

### DETAILED DESCRIPTION

The disclosure relates to methods and systems of performing entity discovery based on an entity discovery model. Entity discovery refers to one or more computational processes that attempt to identify an entity when the identity of the entity is unknown. Entity discovery may be performed in order to address issues in which an electronic alert message is to be provided to a target entity but there is no communication link to the target entity. For example, a communication link between an alert system and the target entity may be unavailable when the target entity has not been onboarded to receive electronic alert messages from the alert system. There may be other instances when a communication link to the target entity is unavailable and other instances in which an entity is to be identified. To address the unavailability of a communication link to the target entity, the entity discovery model may identify a relay entity that is associated with the target entity. The computer system may transmit the electronic alert message to the relay entity, which relays the electronic alert message to the target entity.

The entity discovery model may perform entity discovery based on one or more discovery parameters and a plurality of discovery stages. A discovery parameter may refer to a data value that the entity discovery model uses to identify an entity. The particular type of discovery parameter depends on the context in which entity discovery is performed. Each discovery stage of the entity discovery model may independently attempt to identify the relay entity. The plurality of discovery stages may include an inference mapping stage, a temporal logic stage, a data warehouse mining stage, a machine-learning model stage, and/or other discovery stages. The inference mapping stage may use entity relationships that are modeled to associate the target entity with the relay entity. The temporal logic stage may leverage time-bound data to associate the target entity with the relay entity. The data warehouse mining stage may query a plurality of data structures in a data warehouse to mine linkages between various entities, including the relay entity and the target entity. The machine-learning model stage may use a model trained to identify an entity. For example, the machine-learning model stage may execute a model trained to identify the relay entity based on training data that includes mappings between various entities.

One issue of performing entity discovery is the computational overhead of executing multiple discovery stages. Computational overhead refers to processor, memory, and/or other use of computing resources by a computer to perform computational operations. In some examples, each discovery stage may impose a different amount of computational overhead. For example, a discovery stage may require more processing power and/or memory than another discovery stage. In some examples, each discovery stage may have different levels of deterministic outcomes. For example, a discovery stage may be more deterministic, and less probabilistic, than another discovery stage.

In some examples, the entity discovery model may be configured to run in a waterfall execution to mitigate against the computational overhead of the plurality of discovery stages and/or to take into account the deterministic qualities of each discovery stage. For example, waterfall execution may execute the plurality of discovery stages in an order that is prioritized based on the computational overhead and/or deterministic qualities of the discovery stages. The discovery stages in the waterfall execution may be executed in the prioritized order only after a prior discovery stage finished execution. If a prior discovery stage successfully identifies the entity, then the waterfall execution terminates, saving the computational overhead of the remaining discovery stages. In some examples, the prioritized order may ascend in computational overhead so that a later stage requires more computational overhead than an earlier stage, which may further reduce the overall computational overhead used by the entity discovery model.

Alternatively, or additionally, the discovery stages may be arranged based on their level of determinism-probability. For example, the prioritized order may ascend in probabilism and descend in determinism. In this example, the waterfall execution of the entity discovery model may yield more definitive, less probabilistic, results earlier. When the prioritized order is based on both computational resource consumption and deterministic qualities, the waterfall execution may yield more deterministic results earlier while also reducing computational overhead of executing more probabilistic stages that may be unnecessary.

In some examples, it may be more advantageous to perform entity discovery as quickly as possible. In these examples, the entity discovery model may be configured to use a parallel execution. Unlike waterfall execution, parallel execution involves executing a given discovery stage without waiting for another discovery stage to finish. Typically, though not necessarily, the discovery stages are executed simultaneously so that two or more of the discovery stages overlap one another even though they may finish executing at different times. For example, parallel execution may involve all stages executing at the same time, although they may finish executing at different times. Thus, execution time of the entity discovery model configured in parallel execution may be reduced compared to the waterfall execution.

In parallel execution, a system may aggregate results of the different discovery stages. From among the aggregated results, the computer system may select one of the results or use an aggregate of all the results. If more than one discovery stage generated an entity identification, the computer system may use the prioritized order to determine which one of the results take precedence. In other examples, instead of selecting one of the results, the system may use an aggregate of results, such as polling results by counting any agreed upon results. For example, if two stages identified a first entity and one stage identified a second entity, then the system may select the first entity for the discovery result. If there is a tie, then the system may use the prioritized order as a tie breaker in which a higher-prioritized stage will act as the tie-breaker.

Entity discovery based on the entity discovery model may be used in various contexts. In one example context, an alert system may transmit electronic alert messages to merchant entities when anomalous activity is detected for a payment transaction and/or payment account involving the merchant entity. However, if a merchant entity that should be alerted is not onboarded to receive electronic alert messages from the alert system, then a communication link to the merchant entity may be unavailable. In this scenario, the alert system may perform entity discovery to identify an acquirer entity that submits payment transactions through a payment network on behalf of the merchant entity. The acquirer entity may act as a relay entity that transmits the electronic alert message to the merchant entity, which in this example is the target entity. In the foregoing example, the discovery parameters may include data such as a merchant descriptor, a geographic location associated with the merchant, and/or other data known about a transaction relating to a merchant entity.

Other contexts in which an acquirer entity or other entity is identified may be used as well. Furthermore, entity discovery may be used in other contexts in which an entity is to be identified. For example, a target device in a computer network may be unable to be reached for various reasons, such as not yet being configured, unavailable access to a wide area network, and/or other reasons. In this context, entity discovery may be performed to identify a relay device on the wide area network that may have a local communication link to the target device. In the foregoing example, the discovery parameters may include data such as a domain to which the device belongs, an internet service provider that services the device, and/or other data known about the device. Still other contexts may be used based on the disclosures herein.

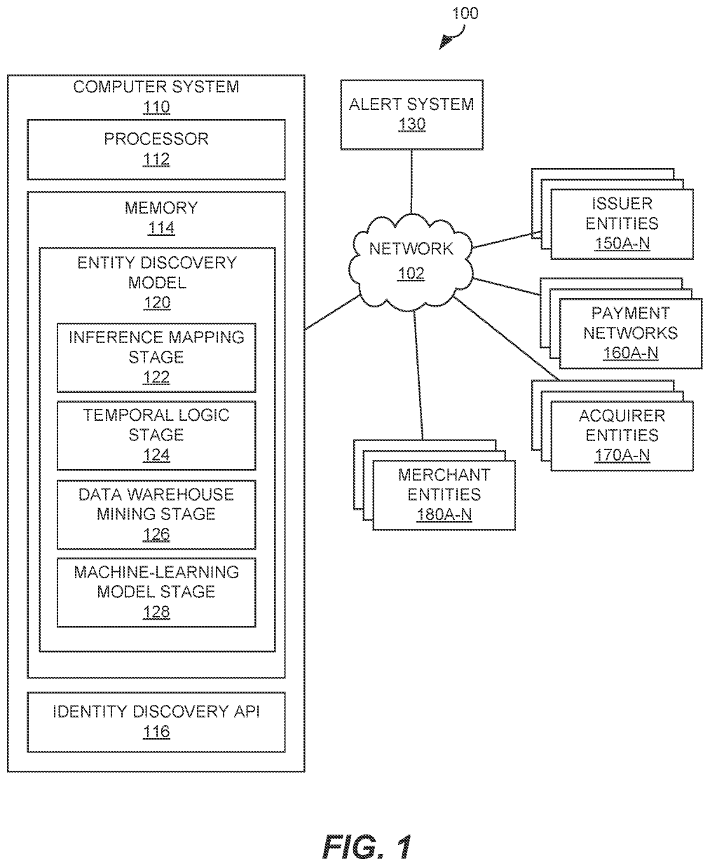

Having described a high-level overview of system operations and example use of the system, attention will now turn to an example of a system environment in which entity discovery may be performed. For example, FIG. 1 illustrates an example of a system environment 100 of performing entity discovery based on an entity discovery model 120. The system environment 100 may include a computer system 110, issuer entities 150 (illustrated as issuer entities 150A-N), payment networks 160 (illustrated as payment networks 160A-N), acquirer entities 170 (illustrated as acquirer entities 170A-N), merchant entities 180 (illustrated as merchant entities 180A-N), and/or other features. At least some of the components of the system environment 100 may be connected to one another via a network 102, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

The computer system 110 may include one or more computing devices that identify entities such as acquirer entities 170 based on alert data from the alert system 130. For example, the one or more computing devices of the computer system 110 may each include a processor 112, a memory 114, an entity discovery Application Programming Interface (API) 116, and/or other components. The processor 112 may be a semiconductor-based microprocessor, a central processing unit (CPU), an application specific integrated circuit (ASIC), a field-programmable gate array (FPGA), and/or other suitable hardware device. Although the computer system 110 has been depicted as including a single processor 112, it should be understood that the computer system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

The memory 114 may store an entity discovery model 120 that may be executed by the processor 112 to perform entity discovery. The entity discovery model 120 may include multiple stages, such as an inference mapping stage 122, a temporal logic stage 124, a data warehouse mining stage 126, a machine-learning model stage 128, and/or other stages. The term “stage” or “discovery stage” refers to computational logic that specifically programs the computer system 110 to perform one or more operations that perform entity discovery in a way that is distinct from other stages. In this way, a given discovery stage attempts to identity an entity using techniques and logic that differ from other discovery stages. As such, using a combination of different discovery stages, the entity discovery model 120 may perform entity discovery in different ways so that if one discovery stage fails to identify the entity, other discovery stages may be able do so. In the examples that follow, entity discovery will be described in the context of identifying an acquirer entity identifier associated with a merchant entity that is included in an electronic alert message. The examples that follow may be used to identify an acquirer entity 170 to which to transmit an alert relating to a merchant entity 180 that has not been onboarded to use the alert system 130. However, some or all of the disclosed entity discovery may be used in other contexts in which an entity is to be identified.

### Inference Mapping

The inference mapping stage 122 may perform entity discovery based on inferred knowledge from previously-discovered entity relationships, which are used to infer the identity of an entity. For example, different networks may use different entity identifiers for the same entity. In particular, a first payment network 160A may identify an acquirer entity 170 using a first acquirer entity identifier, which may be assigned by the first payment network 160A. The acquirer entity 170 may also be registered to interact with a second payment network 160B, which also assigns its own second acquirer entity identifier to the acquirer entity 170. In this example, the acquirer entity 170 may be associated with two acquirer entity identifiers-a first acquirer entity identifier from the first payment network 160A and a second acquirer entity identifier from the second payment network 160B. From the perspective of the first payment network, the first acquirer entity identifier will be referred to as an “in-network” identifier and the second acquirer entity identifier will be referred to as an “out-of-network” identifier.

A transaction submitted by the acquirer entity 170 to the second payment network 160B may include the second acquirer entity identifier. When analyzing the transaction, the first payment network 160A may be unable to determine that the transaction relates to the acquirer entity 170 because the transaction includes the second acquirer entity identifier, which is an out-of-network identifier not known to the first payment network 160A. By using modeled entity relationships. the inference mapping stage 122 may leverage inferred knowledge of relationships between merchant entities 180 and acquirer entities 170 across payment networks 160A-N to be able to match in-network identifiers with out-of-network identifiers. For example, the system may infer that the acquirer entity 170, when submitting transactions on behalf of a merchant entity 180, will use the same merchant descriptor regardless of which payment network is being used.

To illustrate, a first transaction submitted to the first payment network 160A by the acquirer entity 170 involving a merchant entity 180 will include a merchant descriptor and the first acquirer entity identifier. This may occur when a customer presents a payment card processed by the first payment network 160A to the merchant entity 180 for payment. A second transaction submitted to the second payment network 160B by the acquirer entity 170 involving the merchant entity 180 will include a merchant descriptor and the second acquirer entity identifier. This may occur when a customer presents a payment card processed by the second payment network 160B to the merchant entity 180 for payment. The system leverages an inference that the second transaction submitted to the second payment network 160B by the acquirer entity 170 involving the same merchant entity 180 will include the same merchant descriptor. Thus, through a relationship between a merchant entity 180 and an acquirer entity 170 that submits payment transactions on behalf of the merchant entity 180 to the first payment network 160A and the second payment network 160B, the system may be able to infer that the first acquirer entity identifier and the second acquirer entity identifier both identify the same acquirer entity 170.

Put another way, if the computer system 110 is operated from the perspective of the first payment network, the inference mapping stage 122 may be able to infer the identity of the acquirer entity through the first acquirer entity identifier (known to the computer system 110) via the second acquirer entity identifier, successfully matching the first acquirer entity identifier with the second acquirer entity identifier. Such inference results may be used in the inference mapping stage 122 to identify entities such as acquirer entities in a platform-agnostic way.

In some examples, the matched in-network identifiers and the out-of-network identifiers may be stored in a mapping datastore. In these examples, the inference mapping stage 122 may query the mapping datastore to perform entity discovery. This may deterministically identify an in-network identifier such as the first acquirer entity identifier known to the first payment network based on an out-of-network identifier such as the second acquirer entity identifier from the second payment network. An example of entity modelling that may be used in the inference mapping stage 122 is described in U.S. patent application Ser. No. 17/894,910, filed on Aug. 24, 2022, entitled, “Platform-agnostic entity identification through computational modeling,” which is incorporated by reference in its entirety herein for all purposes.

### Temporal Mapping

The temporal logic stage 124 may perform entity discovery based on time-bound knowledge of historical datasets. The historical datasets may include the identity of a relay entity, such as a merchant entity, linked with the entity to be identified, such as an acquirer entity. To illustrate, the historical datasets may include prior alert datasets from the alert system 130, historical payment transactions and chargebacks, and/or other datasets.

The alert datasets may include information exchanged between issuer entities 150, the alert system 130, and merchant entities 180. For example, whenever an issuer entity 150 detects suspicious activity such as fraud relating to a transaction at a merchant entity 180 using one of its issued accounts (such as when a credit card or other payment method linked to an issued account is used), the issuer entity 150 may transmit an alert to the alert system 130. The alert system 130 may transmit an alert to the merchant entity 180 indicating the suspicious activity. In response, the merchant entity 180 may intervene by cancelling the transaction or refunding an amount of the transaction to avoid chargeback processing from the account holder. The merchant entity 180 may report, to the alert system 130, the interventive action or other information relating to the alert. The refund may be initiated by the merchant entity 180 through its acquirer entity 170, which may submit a refund transaction to the appropriate payment network 160. Because such refunds generally occur within a specified time after the transaction (and alert from the issuer entity 150 was transmitted), refunds occurring within a threshold time period may be deemed to be related to the original alert. The threshold time period may be set to the length of time it usually takes for a payment transaction to reach settlement, typically 24 to 48 hours, although other threshold time periods may be used. By monitoring this historical dataset with timebound, temporal threshold time periods in place, the temporal logic stage 124 may be able to match acquirer entities 170 with merchant entities 180.

### Data Warehouse Mining

The data warehouse mining stage 126 may perform entity discovery based on data warehouse mining. For example, a data warehouse that stores authorization data from transactions may be queried to perform entity discovery. The query may include a merchant entity identifier, a merchant descriptor, an entity code, and/or other information that is cross-referenced with the data warehouse to identify an acquirer entity 170. For example, a given merchant entity identifier may be available to the data warehouse mining stage 126. The merchant entity identifier may be used to query the data warehouse, which may store merchant entity identifiers, merchant descriptors, entity codes, and/or other data in various datastores.

In some examples, to ensure that the merchant entity identifier is used to retrieve appropriate data records, the data warehouse mining stage 126 may check that any records found in the data warehouse are correctly associated with an entity code indicating that the corresponding record relates to a “merchant entity” entity. Alternatively, or additionally, the data warehouse mining stage 126 may check that any records found in the data warehouse are correctly associated with an appropriate merchant descriptor. The foregoing may ensure that records in the data warehouse relate to an entity since the merchant entity identifier may be a number or other identifier that could refer to any type of entity. For example, a merchant entity identifier “123456” may, depending on the context and data warehouse queried, refer to another data object also identified by “123456.” By cross-referencing the data warehouse with the merchant entity identifier “123456” along with other data such as the entity code or merchant descriptor, the data warehouse mining stage 126 may ensure that the appropriate data records relating to a merchant entity code having an identifier “123456” is obtained. The foregoing may ensure that the queried merchant entity identifier “123456” actually relates to a merchant entity.

### Machine-Learning Model

The machine-learning model stage 128 may perform entity discovery based on a machine-learning model trained to identify entities. In some examples, the machine-learning model may be trained using supervised learning techniques. In particular, the machine-learning model may include classification algorithms that attempt to estimate a mapping function from input feature variables (discovery parameters) to discrete or categorical output variables (labels identifying an acquirer entity). Examples of the common classification algorithms include logistic regression, Naïve Bayes, decision trees, and K Nearest Neighbors.

To illustrate, an example of features used for training the machine-learning model during training and validation will be described in the context of discovery an acquirer entity 170 based on information known about a merchant entity 180. These features may be used as discovery parameters for input to the trained machine-learning model. The alert system 130 may receive alert data relating to a transaction involving a merchant descriptor “ABCMerchant #123”. The alert data may indicate potential suspicious activity, such as fraud or a possible chargeback initiated by a cardholder. Because merchant descriptors are highly variable, the merchant descriptor may be processed to generate features for training during training and validation. For example, “ABCMerchant” in this case may refer to the name of a merchant chain and “#123” may refer to a store number in the merchant chain. The computer system 110 may identify a geographic location associated with the store number from prior transactions. For example, the computer system 110 may query prior transactions involving the merchant descriptor to identify geographic location data such as street address, city name, zip code, country name, latitude/longitude coordinates, and/or other data that indicates a location of the merchant entity 180 described by the merchant descriptor. The computer system 110 may use the name of the merchant chain, the geographic location data, and/or other merchant data as features for training. Of course, these features for training will be combined with other merchant data such as other merchant names and geographic locations in the training and validation data sets.

Once the feature set is established, the computer system 110 may train the machine-learning model based on various modeling techniques or architectures such as gradient boosting (in particular examples, Gradient Boosting Machines (GBM), XGBoost, LightGBM, or CatBoost). Gradient boosting is a machine learning technique for regression and classification problems, which produces a prediction model in the form of an ensemble of weak prediction models, typically decision trees. GBM may build a model in a stage-wise fashion and generalizes the model by allowing optimization of an arbitrary differentiable loss function. However, other ML techniques may be used as well, such as neural networks. A neural network, such as a recursive neural network, may refer to a computational learning system that uses a network of neurons to translate a data input of one form into a desired output. A neuron may refer to an electronic processing node implemented as a computer function, such as one or more computations. The neurons of the neural network may be arranged into layers. Each neuron of a layer may receive as input a raw value, apply a classifier weight to the raw value, and generate an output via an activation function. The activation function may include a log-sigmoid function, hyperbolic tangent, Heaviside, Gaussian, SoftMax function and/or other types of activation functions.

Once trained, the machine-learning model may make predictions based on input discovery parameters during the machine-learning model stage 128. For example, when provided with one or more discovery parameters, the machine-learning model may predict whether the one or more discovery parameters map to one or more acquirer entities. Put another way, the machine-learning model may be trained to predict a probability that an acquirer entity corresponds to the one or more discovery parameters. It should be noted that the output of the machine-learning model may be multiple probabilities, with each probability corresponding to a likelihood that a respective acquirer entity 170 is associated with the one or more discovery parameters. If the probability that a given acquirer entity 170 is associated with the one or more discovery parameters meets or exceeds a threshold probability, then that acquirer entity 170 may be deemed to be identified by the machine-learning model. If multiple acquirer entities 170 each have a probability that meets or exceeds the threshold probability, then the acquirer entity 170 having the highest probability may be selected as the identified entity. In other examples, all acquirer entities 170 may be output as a possible identified entity. The threshold value may be set to a default value and/or be configured based on feedback data that indicates whether or not previous probabilities correctly predicted an appropriate acquirer entity 170.

### Accessing the Entity Discovery Model Through an API

The entity discovery API 116 may provide a programming interface for performing entity discovery. For example, the entity discovery API 116 may include a RESTful (REST) Application Programming Interface (API), a Simple Object Access Protocol (SOAP) interface, and/or other type of interface that may provide access to the historical data and/or other data. The entity discovery API 116 may be accessed via API calls from programming languages such as JAVA, .NET, a dedicated PYTHON extension, and/or other languages. Various systems may use the entity discovery API 116 to identify an entity based on normalized API parameter inputs. Normalized API parameter inputs refers to a standardized way in which to make requests to the entity discovery API 116. For example, normalized API parameter inputs may be a way in which to provide data and/or API calls to the entity discovery API 116 in way that is consistent and what is expected as input to the entity discovery model 120. The alert system 130, issuer entities 150, acquirer entities 170, merchant entities 180, and/or other systems may make API calls that include inputs for identifying an entity. In a particular example, various systems may use the entity discovery API 116 to identify an acquirer entity 170 that is involved in a fraud alert from an issuer entity 150.

Upon receipt of a discovery request via an API call, the entity discovery API 116 may execute a data service that performs entity discovery using the entity discovery model 120. For example, the API call may include one or more discovery parameters used as input to the entity discovery model 120. It should be noted that execution of the entity discovery model 120 is not limited to initiation via an API call to the identity discovery API 116. For example, other processes may perform entity discovery using the entity discovery model 120.

In one example operation, the computer system 110 may perform entity discovery to identify an acquirer entity 170 that is able to relay electronic alert messages from the alert system 130 to a merchant entity 180 that is not onboarded to receive alerts from the alert system 130. A merchant entity 180 may accept a payment from a cardholder via a cardholder's payment account identified by a payment device. The payment device may encode or otherwise store a payment account identifier. For example, the payment device may include a payment card (such as a credit card), a mobile device programmed with a wallet application, and/or other device that may encode or otherwise store the payment account identifier. The payment account may be branded to operate on a payment network 160, such as the Mastercard® payment network. On behalf of a merchant entity 180, an acquirer entity 170 may submit an authorization request for payment in connection with the payment account to the payment network 160. In response to the authorization request, the payment network 160 may contact an issuer entity 150, such as a financial institution, that issued the payment account to the cardholder to ensure that the payment is authorized. In some instances, the issuer entity 150 may, at the time of the authorization request or later, determine that there is an anomaly with the payment transaction. The anomaly may include an inquiry from a cardholder indicating that the cardholder does not recognize the payment transaction, potential fraudulent use of the payment account (such as via a payment card), and/or other type of anomaly.

The issuer entity 150 may transmit an alert to the alert system 130 to indicate the anomaly. Responsive to the alert, the alert system 130 may ordinarily generate an electronic alert message based on the alert and transmit the electronic alert message to the merchant entity 180 for real-time mitigation. However, in many instances, the alert system 130 may determine that the merchant entity 180 has not been onboarded to receive alerts. Therefore, a communication link that the alert system 130 may use to transmit the electronic alert message to the merchant entity 180 is unavailable. As such, the alert system 130 may perform entity discovery to identify an acquirer entity 170 that processes payments on behalf of the merchant entity 180 and may relay the electronic alert message to the merchant entity 180. Entity discovery may be performed via API call to the entity discovery API 116, direct execution of the entity discovery model 120, and/or other ways to obtain an output of the entity discovery model 120.

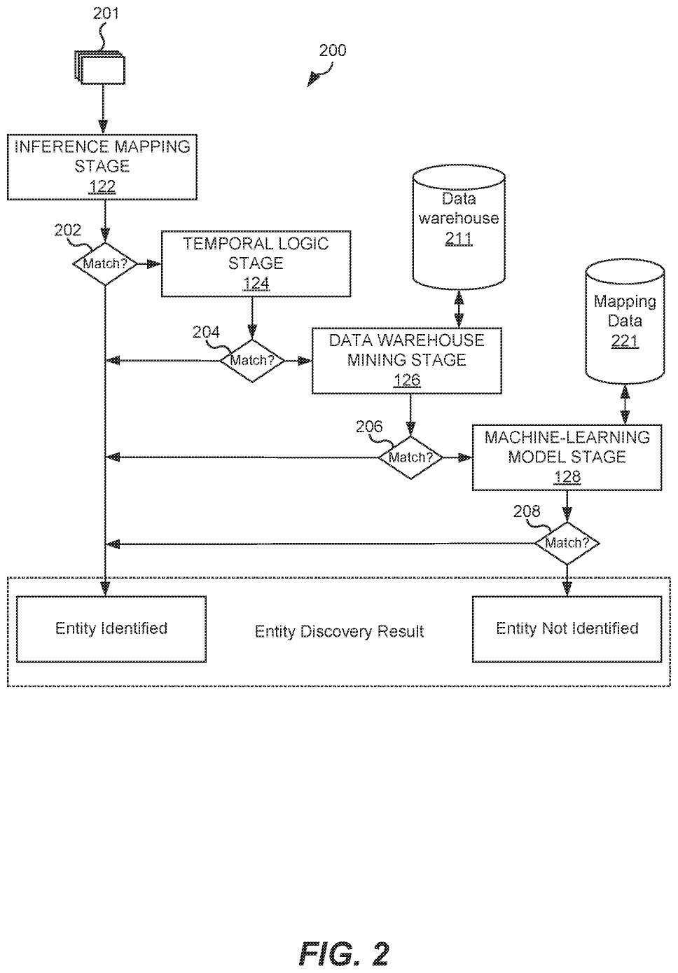

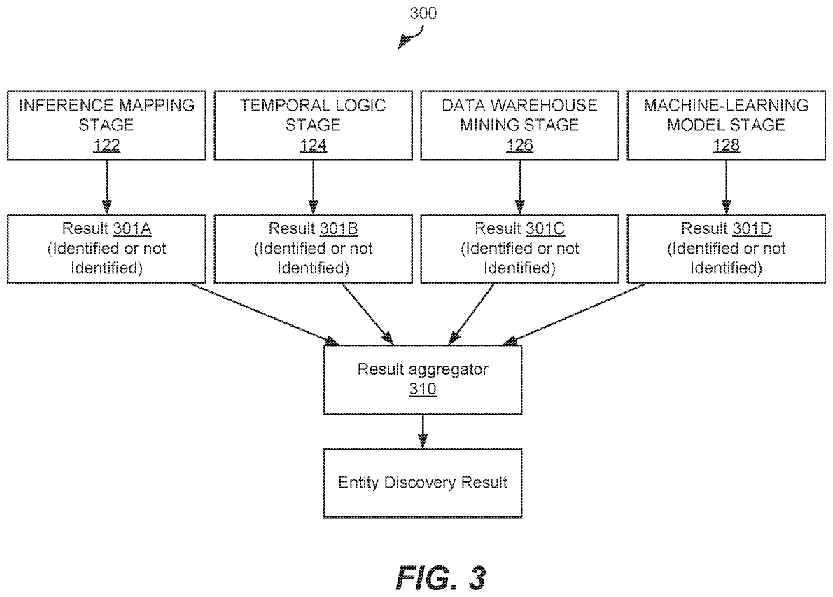

The entity discovery model 120 may initiate the multiple stages in a waterfall execution or parallel execution, as respectively illustrated in FIGS. 2 and 3. For example, FIG. 2 illustrates an example of performing entity discovery based on waterfall execution 200 of discovery stages in the entity discovery model 120. During waterfall execution 200, each of the discovery stages (other than the first stage) may follow a prior stage after the prior stage has failed to identify the entity. If the prior stage successfully identifies the entity, then the waterfall execution 200 is terminated. Thus, waterfall execution 200 may reduce computational overhead of executing the entity discovery model 120. In some examples, the discovery stages may be arranged in an order based on the computational overhead imposed by each stage. For example, the order may ascend in computational overhead so that an earlier stage requires less computational overhead than a later stage, which may further reduce the overall computational overhead used by the entity discovery model 120 to perform entity discovery.

Additionally, or alternatively, the discovery stages may be arranged based on their level of determinism-probability. For example, the order may ascend in probabilism and descend in determinism. Simply put, earlier stages may be more deterministic and less probabilistic than later stages. In this manner, the waterfall execution 200 of the entity discovery model 120 may yield more definitive, less probabilistic, results earlier while reducing the need to rely on more probabilistic results, which may also reduce computational overhead of executing more probabilistic stages.

Waterfall execution of the entity discovery model 120 will be described in the context of the example illustrated in FIG. 1, in which alert data 201 that flags an anomaly with a payment transaction is received and entity discovery is performed to identify an acquirer entity 170 that should be alerted to the anomaly.

As illustrated, the inference mapping stage 122 may be the initial stage to execute in the waterfall execution. This is because, in this example, the inference mapping stage 122 may require the least computational overhead and/or be the least probabilistic (most deterministic). At 202, if a match is found, an acquirer entity 170 has been identified by the inference mapping stage 122 and the waterfall execution is terminated, eliminating the additional computational overhead of the remaining stages. On the other hand, if a match is not found, then the waterfall execution initiates the next stage.

As illustrated, the temporal logic stage 124 may execute after the inference mapping stage 122. The temporal logic stage 124 may require more computational overhead and/or more probabilistic (less deterministic) than the inference mapping stage 122. At 204, if a match is found, an acquirer entity 170 has been identified by the temporal logic stage 124 and the waterfall execution is terminated, eliminating the additional computational overhead of the remaining stages. On the other hand, if a match is not found, then the waterfall execution initiates the next stage.

As illustrated, the data warehouse mining stage 126 may execute after the temporal logic stage 124. The data warehouse mining stage 126 may include mining a data warehouse 211, which may be remote from the computer system 110. The data warehouse 211 may include a plurality of data structures that stores data that may be used to identify an entity, such as the acquirer entity 170. These data structures may store different information related to payment transactions processed over the payment network 160. For example, the data warehouse 211 may include merchant descriptor data, acquirer identification data, payment transactions submitted by the acquirer entities 170, payment transactions in which merchant entities 180 are payees, and/or other data. Each of the data structures may be linked with one another. Thus, “mining” may refer to discovering linkages between the data to identify appropriate entity relationships, such as the merchant entities 180 for which acquirer entities 170 submit authorization requests. The data warehouse mining stage 126 may require more computational overhead and/or more probabilistic (less deterministic) than the temporal logic stage 124. At 206, if a match is found, an acquirer entity 170 has been identified by the data warehouse mining stage 126 and the waterfall execution is terminated, eliminating the additional computational overhead of the remaining stages. On the other hand, if a match is not found, then the waterfall execution initiates the next stage.

As illustrated, the machine-learning model stage 128 may execute after the data warehouse mining stage 126. The machine-learning model stage 128 may use mapping data 221 to train, validate, and execute a machine-learning model to predict which acquirer entity 170 is associated with a merchant entity 180. The machine-learning model stage 128 may require more computational overhead and/or more probabilistic (less deterministic) than the data warehouse mining stage 126. At 206, if a match is found, an acquirer entity 170 has been identified by the machine-learning model stage 128 and the waterfall execution is terminated. On the other hand, if a match is not found and no other stages are available, then an acquirer entity 170 has not been identified.

It should be noted that although waterfall execution involves executing one stage only after a prior stage has completed and has failed to identify an entity, the particular order of execution of discovery stages may vary depending on the particular needs and usage of the system. For instance, in one context, the inference mapping stage 122 may require the least computational overhead and/or be the most deterministic. In this context the inference mapping stage 122 may be the initial stage in the waterfall execution. But in another context, the inference mapping stage 122 may not require the least computational overhead and/or not be the most deterministic. In this other context, the inference mapping stage 122 may not be the initial stage in the waterfall execution.

FIG. 3 illustrates an example of performing entity discovery based on parallel execution 300 of discovery stages in the entity discovery model 120. The discovery stages of the parallel execution are similar to those described in FIGS. 1 and 2. Unlike in FIG. 2, the discovery stages are executed in parallel. Parallel execution refers to not waiting for another stage to be complete before initiating a discovery stage. Typically, though not necessarily, the discovery stages are executed simultaneously so that two or more of the discovery stages overlap one another even though they may finish executing at different times. As illustrated, parallel execution may involve all four stages executing at the same time, although they may finish executing at different times. In parallel execution, a result aggregator 310 may aggregate results of the different discovery stages. For example, the result aggregator 310 may access the results 301A-D of the inference mapping stage 122, the temporal logic stage 124, the data warehouse mining stage 126, and the machine-learning model stage 128 and generate the entity discovery result.

The result aggregator 310 may select one of the results 301A-D as the entity discovery result or may use an aggregate of all the results 301A-D. To select one of the results 301A-D, there may be a prioritized order of which takes precedence. The prioritized order may follow the order of the waterfall execution. For example, assuming the prioritized order follows the order of the waterfall execution illustrated in FIG. 2: if the inference mapping stage 122 did not match, the temporal logic stage 124 identified a first entity, the data warehouse mining stage 126 did not match, and the machine-learning model stage 128 identified a second entity, then the result aggregator 310 may select the result of the temporal logic stage 124 (the first entity). This is because the temporal logic stage 124 is prioritized higher than the machine-learning model stage 128 for purposes of selecting the entity discovery result. Instead of selecting one of the results, the result aggregator 310 may use an aggregate of results, such as polling results by counting any agreed upon results. For example, if two stages identified a first entity and one stage identified a second entity, then the result aggregator 310 may select the first entity for the discovery result. If there is a tie, then the result aggregator 310 may use the prioritized order as a tie breaker in which a higher-prioritized stage will act as the tie-breaker.

Having described examples of the discovery stages of entity discovery and types of execution of entity discovery, attention will now turn to examples in which entity discovery is used.

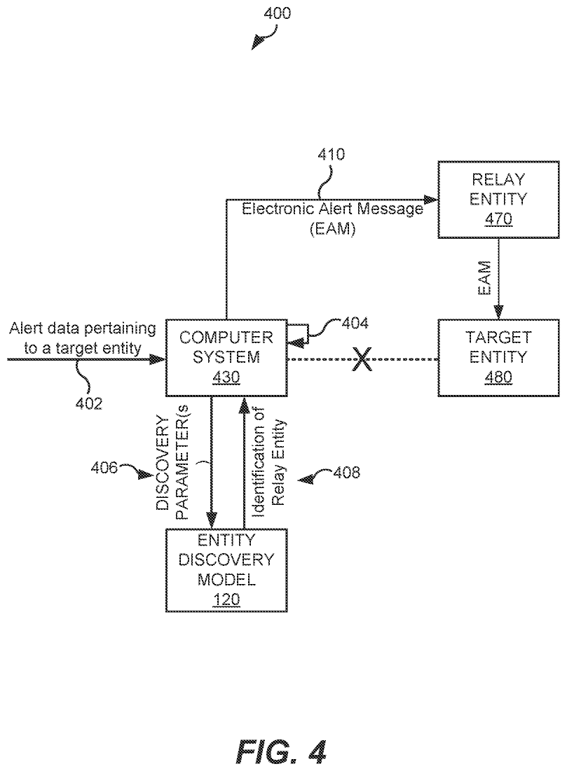

FIG. 4 illustrates an example of a data flow diagram for a method 400 of performing entity discovery to identify a relay entity 470 to establish indirect communication with a target entity 480. The method 400 is illustrated as being performed by a computer system 430. An example of a target entity is a merchant entity (such as a merchant entity 180) that is not onboarded to receive alerts from an alert system 130. An example of a relay entity is an acquirer entity (such as an acquirer entity 170) that submits payment requests on behalf of the merchant entity.

At 402, the method 400 may include receiving alert data pertaining to the target entity 480. The alert data may include information such as one or more discovery parameters relevant to the target entity 480. The alert data may be generated in various contexts. Examples of contexts may include anomalous activity relating to a payment account, event data in a data network that may indicate a network security breach, and/or other contexts.

At 404, the method 400 may include determining that a communication link with the target entity 480 is unavailable to the computer system 430. In FIG. 4, the unavailability of the communication link is illustrated by a dashed line with an “X” indication. The communication may be unavailable for various reasons, such as the target entity 480 not having been onboarded to receive alerts from the computer system 430, not having a wide area network connection, and/or other reasons.

At 406, the method 400 may include performing entity discovery based on an entity discovery model 120 to identify a relay entity 470 that is associated with the target entity 480 and is to relay an electronic alert message to the target entity. The entity discovery model 120 may include a plurality of discovery stages, such as the inference mapping stage 122, the temporal logic stage 124, the data warehouse mining stage 126, the machine-learning model stage 128, and/or other stages. The plurality of discovery stages may each independently attempt to identify the relay entity 470. In some examples, the entity discovery model 120 may be executed in a waterfall execution as illustrated in FIG. 2. In some of these examples, the earlier discovery stages in the plurality of discovery stages may be more deterministic and have less computational overhead than later discovery stages in the plurality of discovery stages to improve discovery efficiency. In some examples, the entity discovery model 120 may be executed in a parallel execution as illustrated in FIG. 3. Performing entity discovery based on the entity discovery model 120 may include making an API call with one or more discovery parameters to the identity discovery API 116 or directly executing the identity discovery model 120 with the one or more discovery parameters.

At 408, the method 400 may include identifying the relay entity 470 based on at least one of the plurality of discovery stages of the entity discovery model 120 having discovered the identity of the relay entity.

At 410, the method 400 may include generating an electronic alert message (EAM) based on the alert data and transmitting the EAM to the relay entity 470 that was identified during entity discovery. The EAM may include some or all of the alert data. The particular data included in the EAM will depend on the context in which the alert data was generated. In the example in which an acquirer entity is identified as a relay entity, the EAM may include a payment account number (such as a credit card number), an indication of the nature of the alert, an authorization date and time, an amount of the transaction, a merchant descriptor, and/or other data. The relay entity 470 may then relay (transmit via a communication network) the EAM to the target entity 480. Although not shown, the target entity 480 may take mitigative action in response to the EAM and report the actions taken back to the relay entity 470, which may relay the response to the computer system 430.

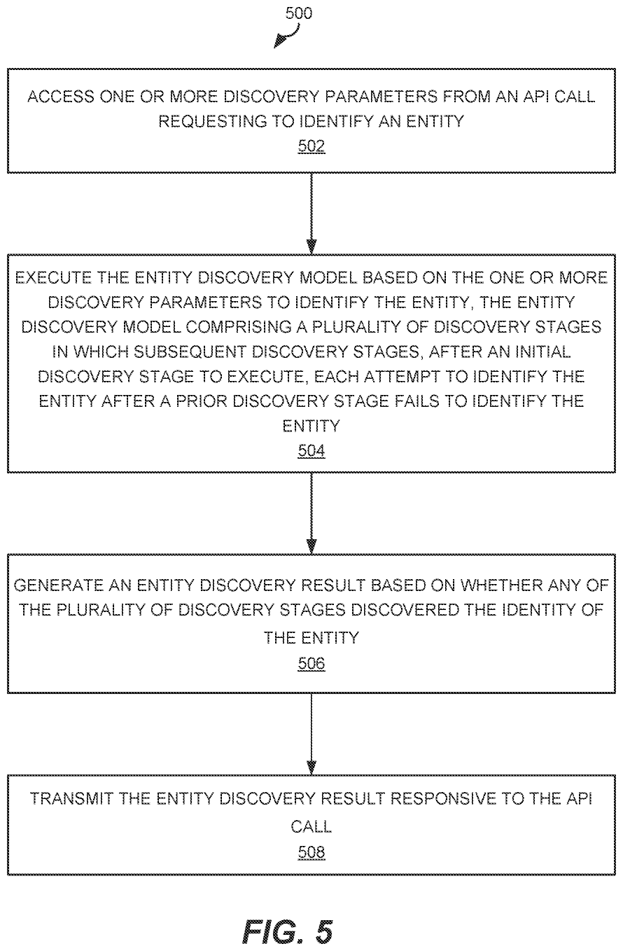

FIG. 5 illustrates an example of a method 500 of identifying a relay entity 470 using an API call and waterfall execution of the entity discovery model 120.

At 502, the method 500 may include accessing one or more discovery parameters from an API call made to the entity discovery API 116.

At 504, the method 500 may include executing the entity discovery model 120 based on the one or more discovery parameters to identify the entity. The entity discovery model 120 may include a plurality of discovery stages in which subsequent discovery stages, after an initial discovery stage to execute, each attempt to identify the entity after a prior discovery stage fails to identify the entity. In other words, the entity discovery model 120 may execute in a waterfall execution as illustrated in FIG. 2.

At 506, the method 500 may include generating an entity discovery result based on whether any of the plurality of discovery stages discovered the identity of the entity. For example, the entity discovery result will include an identification of the entity if any of the plurality of discovery stages discovered the identity of the entity. Otherwise, the entity discovery result will indicate that the entity was not identified. At 508, the method 500 may include transmitting the entity discovery result responsive to the API call.

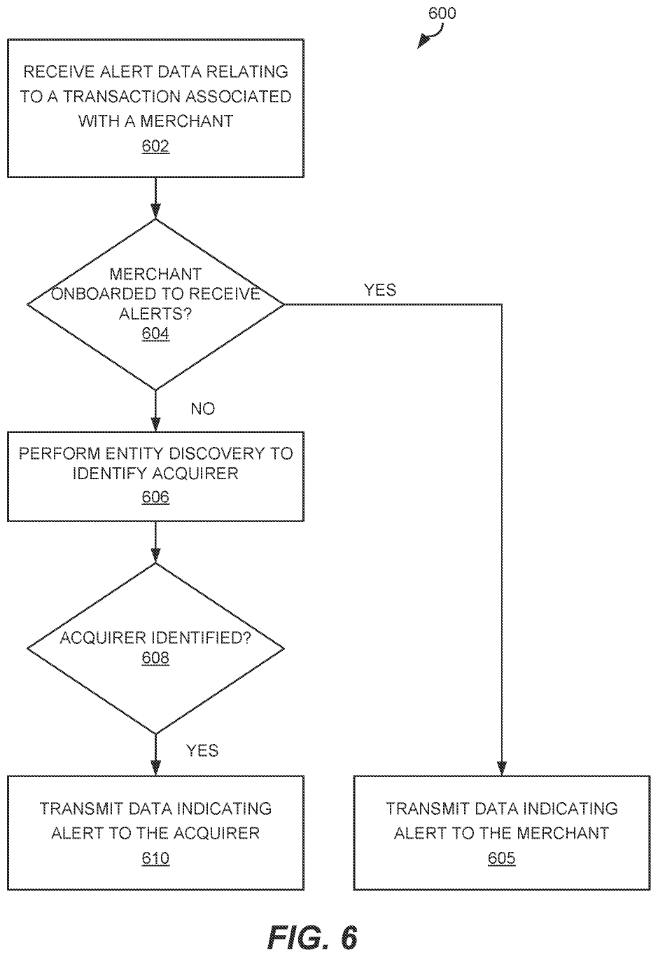

FIG. 6 illustrates an example of a method 600 of identifying an acquirer entity 170 to relay an alert to a merchant entity 180.

At 602, the method 600 may include receiving alert data relating to a transaction associated with a merchant entity 180. The alert data may include merchant entity identifying information such as a merchant descriptor or a merchant entity identifier.

At 604, the method 600 may include determining whether the merchant entity 180 is onboarded to receive alerts. Onboarding refers to registering a merchant entity 180 to receive the alerts, such as in exchange for a fee to receive such alerts. During an onboarding process, the merchant entity identifying information, an electronic address or other information to which to transmit electronic alert messages containing alert data, and/or other onboarding information may be received from the merchant entity 180. If the merchant entity 180 is onboarded, at 605, the method 600 may include transmitting data indicating the alert, such as an EAM, to the merchant entity 180.

If the merchant entity 180 is not onboarded to receive alerts, at 606, the method 600 may include performing entity discovery to identify an acquirer entity 170 that processes payments on behalf of the merchant entity 180. In this example, the acquirer entity 170 to be identified may have pre-existing relationships with an alert system that provides the alert. In this manner, the alert may be transmitted to the acquirer entity 170 so that the acquirer entity may relay the alert to the merchant entity 180. Entity discovery may be performed via an API call to the entity discovery API 116 or direct calls to the entity discovery model 120. In either instance, the method 600 may include providing one or more discovery parameters to the entity discovery model 120.

At 608, the method 600 may include determining whether the acquirer entity 170 has been identified during entity discovery. If so, at 610, the method 600 may include transmitting data indicating the alert to the identified acquirer entity 170. The data indicating the alert may include merchant entity identifying information so that the acquirer entity may relay the data to the merchant entity.

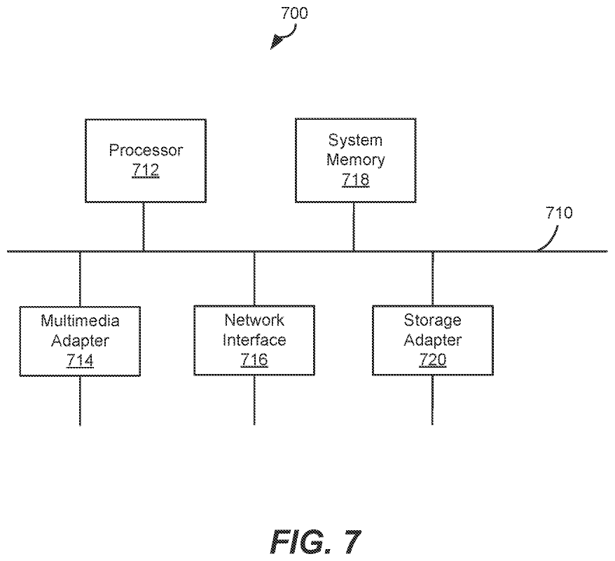

FIG. 7 illustrates an example of a computer system 700 that may be implemented by devices illustrated in FIG. 1. The computer system 700 may be part of or include the system environment 100 to perform the functions and features described herein. For example, various ones of the devices of components of system environment 100 (such as the computer system 110, the alert system 130, the issuer entities 150, the payment networks 160, the acquirer entities 170, and the merchant entities 180) may be implemented based on some or all of the computer system 700. It should be noted that each “entity” illustrated in FIG. 1 may be represented in the figures by its corresponding computer system. For example, transmitting data to an acquirer entity 170 may include transmitting the data to a computer system of the acquirer entity 170.

The computer system 700 may include, among other things, an interconnect 710, a processor 712, a multimedia adapter 714, a network interface 716, a system memory 718, and a storage adapter 720.

The interconnect 710 may interconnect various subsystems, elements, and/or components of the computer system 700. As shown, the interconnect 710 may be an abstraction that may represent any one or more separate physical buses, point-to-point connections, or both, connected by appropriate bridges, adapters, or controllers. In some examples, the interconnect 710 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 710 may allow data communication between the processor 712 and system memory 718, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 712 may control operations of the computer system 700. In some examples, the processor 712 may do so by executing instructions such as software or firmware stored in system memory 718 or other data via the storage adapter 720. In some examples, the processor 712 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 714 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 716 may provide the computer system 700 with an ability to communicate with a variety of remote devices over a network. The network interface 716 may include, for example, an Ethernet adapter, a Fibre Channel adapter, and/or other wired- or wireless-enabled adapter. The network interface 716 may provide a direct or indirect connection from one network element to another and facilitate communication and between various network elements.

The storage adapter 720 may connect to a standard computer readable medium for storage and/or retrieval of information, such as a fixed disk drive (internal or external).

Other devices, components, elements, or subsystems (not illustrated) may be connected in a similar manner to the interconnect 710 or via a network. The devices and subsystems can be interconnected in different ways from that shown in FIG. 7. Instructions to implement various examples and implementations described herein may be stored in computer-readable storage media such as one or more of system memory 718 or other storage. Instructions to implement the present disclosure may also be received via one or more interfaces and stored in memory. The operating system provided on computer system 700 may be MS-DOS®, MS-WINDOWS®, OS/2®, OS X®, IOS®, ANDROID®, UNIX®, Linux®, or another operating system.

The term “model” as used herein may refer to a computational set of operations that identify an entity based on deterministic and/or probabilistic analysis of data. Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “150A-N” does not refer to a particular number of instances of 1501A-N, but rather “two or more.”

The databases (such as the data warehouse 211 and mapping data 221) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

While the disclosure has been described in terms of various specific embodiments, those skilled in the art will recognize that the disclosure can be practiced with modification within the spirit and scope of the claims.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of performing entity discovery based on an entity discovery model, comprising:
a memory configured to store the entity discovery model;
an entity discovery API to receive an API call for interfacing with the entity discovery model, the API call requesting an identity of an entity;
a processor programmed to:
access one or more discovery parameters from the API call;
execute the entity discovery model based on the one or more discovery parameters to identify the entity, the entity discovery model comprising a plurality of discovery stages in which subsequent discovery stages, after an initial discovery stage to execute, each attempt to identify the entity after a prior discovery stage fails to identify the entity,
wherein earlier discovery stages in the plurality of discovery stages are more deterministic and have less computational overhead than later discovery stages in the plurality of discovery stages to improve efficiency of the entity discovery;
generate an entity discovery result based on whether any of the plurality of discovery stages discovered the identity of the entity; and
transmit the entity discovery result responsive to the API call.

2. The system of claim 1, wherein the one or more discovery parameters comprise a merchant descriptor, and the entity to be identified is an acquirer entity that submits electronic authorization requests to a payment network on behalf of a merchant entity described by the merchant descriptor.

3. The system of claim 2, wherein the processor is further programmed to:
determine that the merchant entity described by the merchant descriptor is not onboarded to receive alerts; and
initiate entity discovery based on execution of the entity discovery model to identify the acquirer entity to act as a relay entity to relay an electronic alert message to the merchant entity.

4. The system of claim 2, wherein the plurality of discovery stages comprises an inference mapping stage, and wherein the computer system is further programmed to:
identify, during the inference mapping stage, a mapping between the merchant descriptor and the acquirer entity, the mapping having been generated based on a modeled relationship between the merchant entity and the acquirer entity.

5. The system of claim 2, wherein the plurality of discovery stages comprises a temporal logic stage, and wherein the computer system is further programmed to:
identify the acquirer entity based on the merchant descriptor and one or more time-bound data records comprising the merchant descriptor and an identifier of the acquirer entity.

6. The system of claim 2, wherein the plurality of discovery stages comprises a data warehouse mining stage, and wherein the computer system is further programmed to:
access a remote data warehouse comprising authorization data of a payment network;
query one or more data structures of the remote data warehouse to access one or more data records that associate the merchant descriptor with the acquirer entity; and
identify the acquirer entity based on the one or more data records.

7. The system of claim 2, wherein the plurality of discovery stages comprises a machine-learning model prediction stage, and wherein the computer system is further programmed to:
execute a machine-learning model trained to identify the acquirer entity based on the merchant descriptor.

8. The system of claim 1, wherein the plurality of discovery stages comprises an inference mapping stage, a temporal logic stage, a data warehouse mining stage, and a machine-learning model stage.

9. The system of claim 8, wherein the computer system is further programmed to:
execute the temporal logic stage after the inference mapping stage if the inference mapping stage fails to identify the entity, the data warehouse mining stage after the temporal logic stage if the temporal logic stage fails to identify the entity, and the machine-learning model stage after the data warehouse mining stage if the data warehouse mining stage fails to identify the entity.

10. A computer readable medium for performing entity discovery based on an entity discovery model, the computer readable medium storing instructions that, when executed by a processor of a computer system, programs the processor to:
receive alert data pertaining to a target entity;
determine that a communication link with the target entity is unavailable to the computer system;
perform entity discovery based on an entity discovery model to identify a relay entity that is associated with the target entity and is to relay an electronic alert message to the target entity, the entity discovery model comprising a plurality of discovery stages that each independently attempt to identify the relay entity, wherein at least a first discovery stage from among the plurality of discovery stages is more deterministic and has less computational overhead than at least a second discovery stage from among the plurality of discovery stages;
identify the relay entity based on at least one of the plurality of discovery stages of the entity discovery model having discovered the identity of the relay entity; and
transmit an indication of the electronic alert message to the relay entity.

11. The computer readable medium of claim 10, wherein the entity discovery model is configured to execute in a waterfall execution.

12. The computer readable medium of claim 10, wherein the target entity comprises merchant entity and the relay entity comprises an acquirer entity that submits authorization requests on behalf of the merchant entity.

13. The computer readable medium of claim 12, wherein the alert data includes a merchant descriptor used to perform entity discovery to identify the acquirer entity.

14. The computer readable medium of claim 10, wherein the plurality of discovery stages comprises an inference mapping stage, a temporal logic stage, a data warehouse mining stage, and a machine-learning model stage.

15. The computer readable medium of claim 10, wherein the communication link is unavailable because the target entity is not onboarded to receive alerts from the computer system.

16. A method of providing alerts to merchant entities that are unable to be reached, comprising:
receiving, by a processor of an alert system, alert data relating to a transaction associated with a merchant entity;
determining, by the processor, that the merchant entity is not onboarded to receive alerts from the alert system;
performing, by the processor, entity discovery based on an entity discovery model to identify an acquirer entity that is associated with the merchant entity and is to relay an electronic alert message to the merchant entity, the entity discovery model comprising a plurality of discovery stages in which subsequent discovery stages, after an initial discovery stage to execute, each attempt to identify the entity after a prior discovery stage fails to identify the acquirer entity,
wherein earlier discovery stages in the plurality of discovery stages are more deterministic and have less computational overhead than later discovery stages in the plurality of discovery stages to improve discovery efficiency;
identifying, by the processor, the acquirer entity based on at least one of the plurality of discovery stages having discovered the identity of the acquirer entity; and
transmitting, by the processor, an electronic alert message to the acquirer entity, the electronic alert message being based on the alert data.

17. The method of claim 16, wherein the plurality of discovery stages comprises an inference mapping stage, the method further comprising:
identifying, during the inference mapping stage, a mapping between a merchant descriptor and the acquirer entity, the mapping having been generated based on a modeled relationship between the merchant entity and the acquirer entity.

18. The method of claim 16, wherein the plurality of discovery stages comprises a temporal logic stage, the method further comprising:
identifying the acquirer entity based on a merchant descriptor and one or more time-bound data records comprising the merchant descriptor and an identifier of the acquirer entity

19. The method of claim 16, wherein the plurality of discovery stages comprises a data warehouse mining stage, and wherein the computer system is further programmed to:
accessing a remote data warehouse comprising authorization data of a payment network;
querying one or more data structures of the remote data warehouse to access one or more data records that associate a merchant descriptor with the acquirer entity; and
identifying the acquirer entity based on the one or more data records.

20. The method of claim 16, wherein the plurality of discovery stages comprises a machine-learning model prediction stage, the method further comprising:
executing a machine-learning model trained to identify the acquirer entity based on a merchant descriptor.
